(19) United States
(12) Patent Application Publication
(10) Pub. No.: US 2023/0334995 A1
(43) Pub. Date: Oct. 19, 2023

(54) Mobile Body Control System

(71) Applicant: Hitachi, Ltd., Chiyoda-ku, Tokyo (JP)

(72) Inventors: Kenji IMAMOTO, Tokyo (JP); Mikio BANDO, Tokyo (JP); Takahiro ITO, Tokyo (JP); Keiichi KATSUTA, Tokyo (JP)

(21) Appl. No.: 18/024,805

(22) PCT Filed: Feb. 26, 2021
(86) PCT No.: PCT/JP2021/007409

§ 371 Date: Mar. 6, 2023

(30) Foreign Application Priority Data
Sep. 25, 2020 (JP) 2020-161075

(51) Int. Cl. G08G 5/00; G08G 5/04

(52) U.S. Cl. CPC G08G 5/006; G08G 5/045; G08G 5/0013; G08G 5/0069

(57) ABSTRACT

The purpose is to provide a mobile body control system that can more appropriately perform control of a mobile body capable of vertical takeoff and landing. Comprised are a ground monitoring device (10), and a mobile body control device (20) that can communicate with the ground monitoring device (10). The mobile body control device (20) controls the flight of mobile bodies (51, 61, 71) that are capable of vertical takeoff and landing. The ground monitoring device (10) allocates flight routes (52, 62, 72) when the mobile bodies (51, 61, 71) do takeoff and landing, and is also characterized in that when there is an interference space (80) between one flight route (62) and another flight route (72), unless the one fight route (62) is reserved, flight is not permitted on that flight route.

### TECHNICAL FIELD

The present invention relates to a mobile body control system, and more particularly, to a mobile body control system for a mobile body capable of vertical takeoff and landing.

### BACKGROUND ART

In recent years, as a next-generation transportation within a city and between cities, a mobile body using a small electric aircraft or the like capable of flying through the air has come to be developed. Under this circumstance, because a plurality of mobile bodies come and go, control for preventing collision is required.

For example, Patent Literature 1 describes a technique for setting flight routes not intersecting with one another, and for performing control in such a manner that preceding and subsequent flying objects do not approach each other.

### CITATION LIST

### Patent Literature

PTL 1: JP 2003-6798 A

### SUMMARY OF INVENTION

### Technical Problem

In particular, takeoff and landing ports (skyports) for mobile bodies that are capable of vertical takeoff and landing are often located nearby each other. For this reason, when the mobile bodies take off, the risk of the mobile bodies approaching each other and colliding becomes higher, and advanced control is required.

However, if the flight routes are set in a manner not intersecting with one another, as disclosed in Patent Literature 1, the flight routes that can be set in a specific space will be limited. For mobile bodies capable of vertically taking off from and landing on skyports located nearby each other, it is sometimes difficult to set flight routes not interfering one another. Even if it might be possible to set flight routes not interfering with one another, it would only be in a limited number. Therefore, it might not be possible to achieve a desired operation.

In consideration of the problems described above, an object of the present invention is to provide a mobile body control system that can control a mobile body capable of vertical takeoff and landing, more appropriately.

### Solution to Problem

In order to achieve the object described above, a representative mobile body control system according to the present invention is characterized by including a ground monitoring device, and a mobile body control device capable of communicating with the ground monitoring device, and in that the mobile body control device controls a flight of a mobile body capable of vertical takeoff and landing, and the ground monitoring device allocates a flight route by which the mobile body makes a takeoff and landing, and when there is an interference space between one flight route and another flight route, the ground monitoring device does not permit any flight in the flight route without a reservation of the one flight route.

### Advantageous Effects of Invention

According to the present invention, the mobile body control system can control a mobile body capable of vertical takeoff and landing, more appropriately.

Problems, configurations, and advantageous effects other than those explained above will become clear in the following description of the embodiment.

### BRIEF DESCRIPTION OF DRAWINGS

FIG. 1 is a block diagram illustrating an embodiment of a mobile body control system according to the present invention.

FIG. 2 is a diagram illustrating an example of takeoff and landing of a mobile body applicable to the mobile body control system according to the present invention.

FIG. 3 is a diagram illustrating an example of takeoff and landing of a plurality of mobile bodies, in the mobile body control system according to the present invention.

FIG. 4 is a flowchart illustrating an example of control performed by the mobile body control system according to the present invention.

### DESCRIPTION OF EMBODIMENT

An embodiment according to the present invention will now be explained.

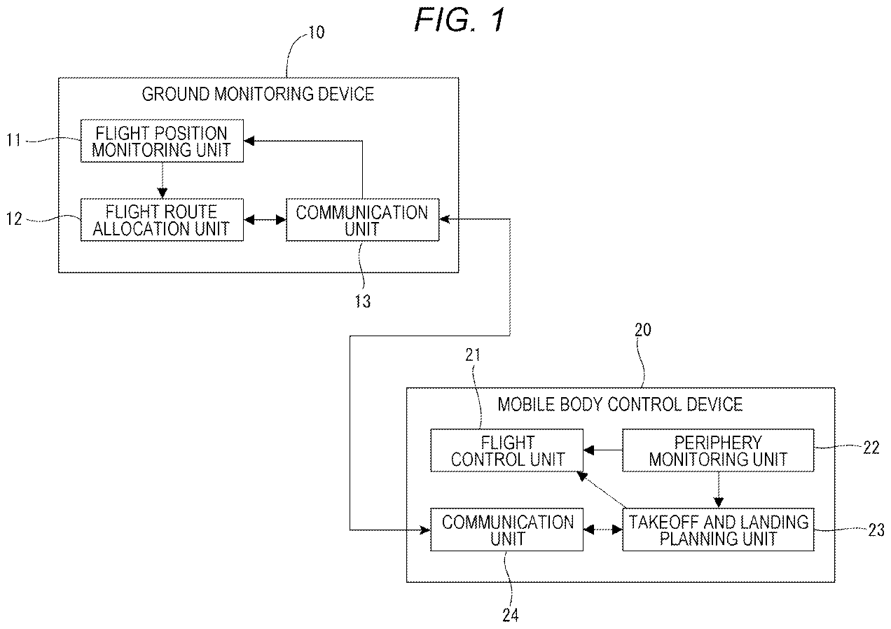

FIG. 1 is a block diagram illustrating an embodiment of a mobile body control system according to the present invention.

The mobile body control system includes a ground monitoring device 10 and a mobile body control device 20, and these devices can communicate with each other wirelessly, for example. The ground monitoring device 10 includes a flight position monitoring unit 11, a flight route allocation unit 12, and a communication unit 13. The mobile body control device 20 includes a flight control unit 21, a periphery monitoring unit 22, a takeoff and landing planning unit 23, and a communication unit 24.

A vertical take-off and landing aircraft (VTOL) capable of vertical takeoff and landing is assumed as a mobile body controlled by this mobile body control system. This mobile body is also applicable as a mobile body that moves with a person on board, and therefore, safety is required. The present invention is also applicable to an unmanned mobile body. The mobile body can be propelled by, for example, a drive device such as a motor or an engine. The mobile body is also provided with a function for going under automatic control, at the time of takeoff and landing.

A skyport is a place on the ground from which and on which one mobile body takes off and lands. Because skyports for vertical take-off and landing aircrafts take up less space for taking off and landing than aircrafts that uses runways, a plurality of skyports can be deployed within a certain area. This enables various operations. For example, the skyports can be deployed in various places such as a rooftop of a building or a vacant space. This mobile body control system can provide control for a plurality of skyports. Therefore, it is possible to increase the number of controllable skyports, e.g., three or more, or five or more.

The ground monitoring device 10 is a device that is installed on the ground, and that monitors and controls takeoff and landing of a plurality of mobile bodies. The ground monitoring device 10 may be implemented by a server, for example. One ground monitoring device 10 may monitor all the mobile bodies, or may monitor only the mobile bodies flying within a predetermined area. The predetermined area herein is, for example, an area required for monitoring and controlling the takeoff and landing of the mobile bodies with respect to the target skyport.

The ground monitoring device 10 may be provided in plurality. In such a configuration, the ground monitoring devices may be configured to assist when one ground monitoring device fails. Furthermore, one of ground monitoring devices 10 may be configured to assist monitoring and control of the area of another ground monitoring device 10, when mobile bodies more than the number that can be monitored by the other ground monitoring device 10 enter the monitoring and control area of the other. The ground monitoring device 10 may have a redundant (duplex) configuration to ensure safety and availability. In other words, a backup system is built by providing the same device such as a server required for monitoring and control, redundantly to the ground monitoring device 10, or by providing the same device in another ground monitoring device 10, for example.

The flight position monitoring unit 11 monitors the flying positions of the respective mobile bodies. A scope of the mobile bodies to be monitored may cover the mobile bodies flying or present within the monitoring area, or may be limited to mobile bodies scheduled to take off or to land. As a way for identifying the positions, a sensor installed on the ground may be used to detect the positions of the mobile bodies, or position information may be received from the mobile bodies. Examples of the sensors installed on the ground include sensors such as a camera, an infrared (IR) camera, a laser radar, and a light detection and ranging (LiDAR). With this, the flight position monitoring unit 11 identifies the positions of the mobile bodies while identifying the space three dimensionally. Furthermore, in a configuration in which the position information is received from a mobile body, the position information is received via the communication unit 13.

The flight route allocation unit 12 defines a flight space taken up by the mobile body that is to take off or to land as a “flight route”. Based on the takeoff and landing plan information received from the mobile bodies, and on the flying positions of the respective mobile bodies, the flight route allocation unit 12 allocates the locations of the skyports for takeoff or landing, and the flight routes to take at the time of takeoff or landing. As a flight route, a takeoff or landing route set to the target skyport is allocated. There may be an “interference space” in which a flight route to be allocated interferes with another flight route. A flight on a flight route including such an “interference space” is prohibited, except for the one having reserved the path. Once the mobile body having the reservation of the other flight route has moved out of the interference space, the flight route allocation unit 12 performs a process of making the flight route available for a next reservation. The reservation is allocated in accordance with a predetermined method.

The priorities at which the reservations are allocated may be determined in advance. The reservations are allocated taking the information of flight priorities received from the takeoff and landing planning unit 23 into consideration. For example, the reservations are allocated on a first-come-first-served basis, or in a manner minimizing the waiting time of each of the mobile bodies. When there are three or more intersecting flight routes within an interference space, reservations are made available from those with the higher priority for the allocation.

Furthermore, it is also possible to use the priority to calculate scheduled time at which a mobile body corresponding thereto is to be permitted to take the target flight route. In this manner, it becomes possible to calculate scheduled waiting time, to know the estimated time of landing at the skyport, and to predict how much the battery and the fuel will be consumed, for each of the mobile bodies.

Definitions of the “flight route” will now be explained. A flight route is a flight space required for a mobile body to fly. As a method for defining flight routes, flight routes corresponding to a plurality of respective skyports may be defined in advance. In this case, by tolerating an interference space, many flight routes including the interference space can be set, instead of a limited number of flight routes avoiding interference. Another method for defining flight routes is to calculate a combination of optimal flight routes based on the number of mobile bodies and the conditions such as the environment around the mobile bodies at that time. With this method, too, various flight routes can be set by tolerating an interference space. The size of the flight route may be changed depending on the conditions. For example, the size of the flight route may be changed depending on the weather condition. For example, when there is a strong wind, it is highly likely for a mobile body to become displaced, so the size of the flight route may be increased.

The communication unit 13 communicates with the communication unit 24 in the mobile body control device 20 wirelessly, as an example. With this, the ground monitoring device 10 can communicate with the mobile body control device.

The mobile body control device 20 is a device that controls the flight of a mobile body. The mobile body control device 20 is basically provided on board the mobile body. The mobile body control device 20 may also be installed on the ground and operate remotely, or the mobile body control device 20 installed in one mobile body may control other mobile bodies that are present nearby, for example. The mobile body control device 20 may have a redundant (duplex) configuration to ensure safety and availability. In other words, a backup system is built by providing the same device such as a computer for monitoring and control, redundantly to the mobile body control device 20, or by providing the same device in another mobile body control device 20, for example.

The flight control unit 21 controls the flight of the mobile body. The flight control unit 21 manages the speed, the direction, and the timing of a flight of the mobile body, and drives the drive device such as a motor required for the flight control, based on a takeoff or landing instruction received from the takeoff and landing planning unit 23.

The periphery monitoring unit 22 monitors the conditions around the mobile body using a sensor or the like. The periphery monitoring unit 22 may be configured, when some obstacle is detected on the flight route, to give an instruction to stop the operation or an instruction of a bypass route, to the flight control unit 21. Examples of the obstacle include a building and a bird. These obstacles can be detected more reliably by detecting the obstacles separately from the detections of the flight position monitoring unit 11. Examples of the sensor herein include a camera, an IR camera, a millimeter wave radar, and an ultrasonic sensor. The sensor is basically provided on board each of the mobile bodies. However, it is also possible, for example, to install the sensor on the ground, and to transmit the result of monitoring on the ground to the mobile bodies, or to install a sensor in one of the mobile bodies and to transmit the result of monitoring to other nearby mobile bodies.

The information about the obstacle may be sent to the ground monitoring device 10, and the ground monitoring device 10 may change or correct the flight route based on the information. Changing the flight route includes changing the route itself, such as changing the skyport to land. A correction of the flight route includes correcting a shape of a part of the flight route so as to avoid the obstacle.

The takeoff and landing planning unit 23 makes a plan of, based on the flight schedule of the mobile body, its own flight route, flight timing, and a skyport to be used, and requests the ground monitoring device 10 to hold a reservation of the flight route. The flight route is determined by the ground monitoring device 10 in response to a request from the takeoff and landing planning unit 23. Upon receiving a notification that a reservation of the flight route is now available from the ground monitoring device 10, the takeoff and landing planning unit 23 instructs the flight control unit to fly along the flight route. To request to hold a reservation from the ground monitoring device 10, the takeoff and landing planning unit 23 transmits information about the flight route, the flight timing of the mobile body, and the location of the skyport to be used. In addition to these pieces of information, the takeoff and landing planning unit 23 may also transmit information such as the flight priority, aircraft performance, and weather conditions.

An example of the flight priority will now be explained. To begin with, there is a method of simply determining priorities in the order of requests received from the mobile bodies. There is another method for elevating the priority of the mobile body having made some payment for a right for a higher priority, for example. There is another method for elevating the priority of a mobile body corresponding to an emergency vehicle (such as a mobile body corresponding to a police vehicle, an ambulance, or a fire engine). In addition, there is also a method for determining the flight priorities based on efficiency of the flight route of the mobile bodies as a whole. Furthermore, there is also a direction considering the amounts of remaining fuel and remaining battery of the mobile body, and giving a higher priority to the mobile body in which the remaining amounts are low. These priorities may be combined and finally defined by the mobile body control device 20.

The communication unit 24 communicates with the communication unit 13 in the ground monitoring device 10 wirelessly, for example.

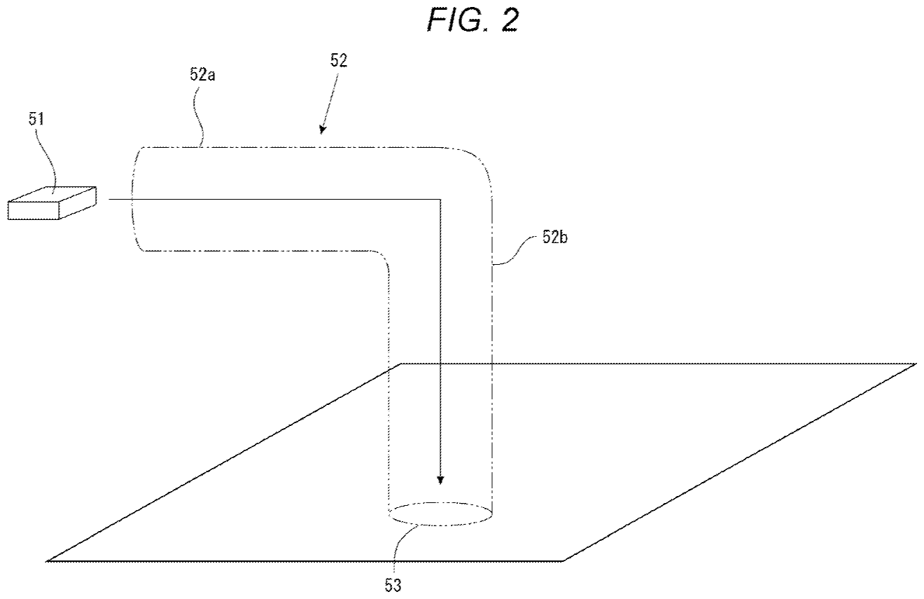

FIG. 2 is a diagram illustrating an example of takeoff and landing of a mobile body applicable to the mobile body control system according to the present invention.

The mobile body 51 is a vertical take-off and landing aircraft (VTOL) capable of vertical take-off and landing. For the mobile body 51 flying in the air to land on the skyport 53, the mobile body takes a flight route 52 and lands on the skyport 53. As the flight route 52, a horizontal or near-horizontal route 52a and a vertical route 52b are assumed. Adequate size of the flight route 52 is ensured for the mobile body 51 to move. The mobile body 51 takes the route 52a to a position above the skyport 53, and then takes the vertical route 52b to land on the skyport 53. In the case of takeoff, this order is reversed, and the mobile body moves up vertically to some height, and then moves laterally. Also for takeoff, an adequate flight route is ensured.

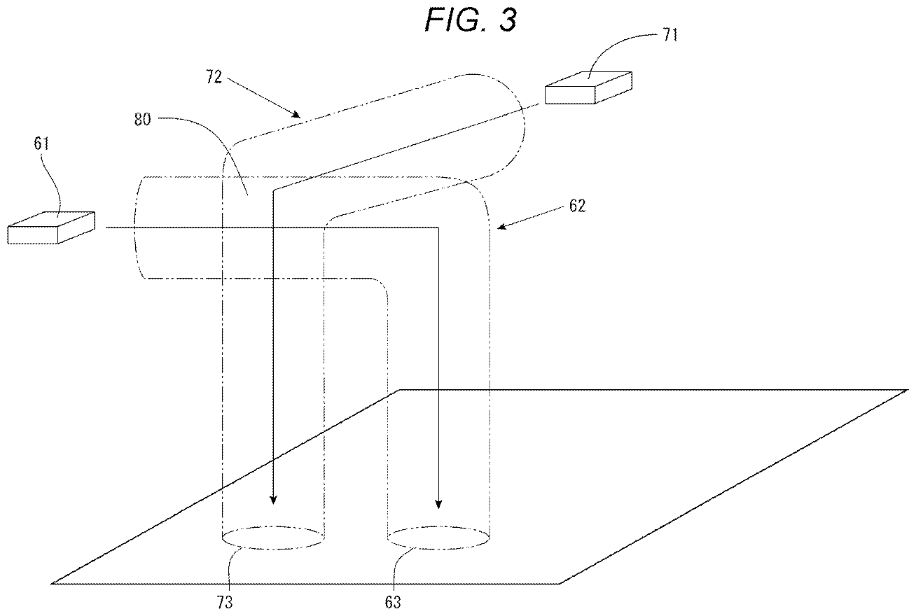

FIG. 3 is a diagram illustrating an example of takeoff and landing of a plurality of mobile bodies, in the mobile body control system according to the present invention.

FIG. 3 schematically illustrates only two flight routes. A first mobile body 61 is about to take a first flight route 62 and land on a first skyport 63. A second mobile body 71 is about to take the second flight route 72 and to land on a second skyport 73. In this example, because there is an interference space 80 between the first flight route 62 and the second flight route 72, there is a risk of collision if the first mobile body 61 and the second mobile body 71 move simultaneously.

To begin with, the ground monitoring device 10 makes the first flight route 62 available for a reservation, to the first mobile body 61 having a higher priority. At this time, the second flight route 72 is not made available for a reservation by the second mobile body 71, because of the presence of the interference space 80. Therefore, at this point, the second mobile body 71 is prohibited from moving across the interference space 80 along the second flight route 72. After the first mobile body 61 has moved out of the interference space 80 along the first 18 flight route 62, the ground monitoring device 10 makes the second flight route 72 available for a reservation, to the second mobile body 71. The second mobile body 71 is then allowed to take the second flight route 72 and land on the second skyport 73. The same kind of control is possible at the time of takeoff.

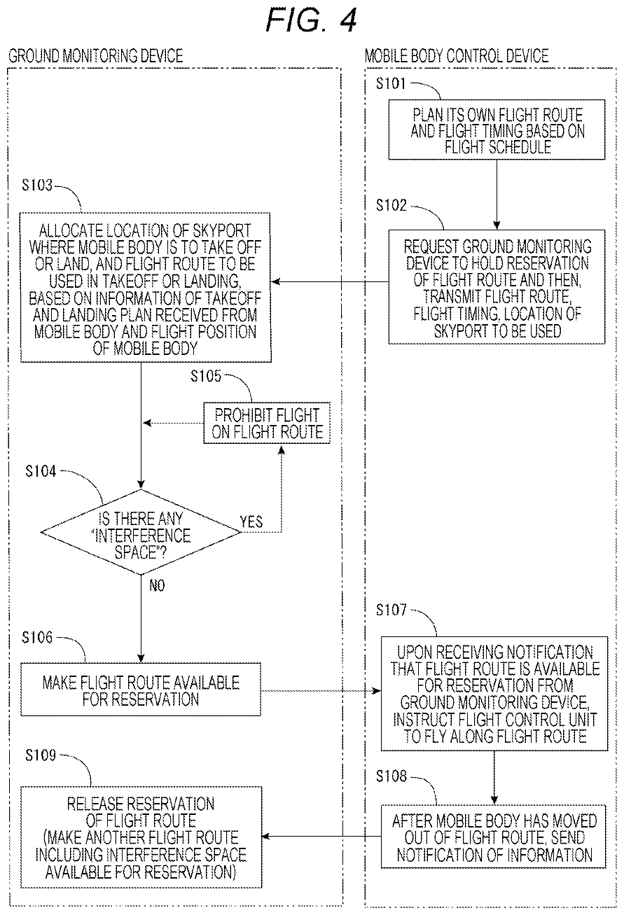

FIG. 4 is a flowchart illustrating an example of control performed by the mobile body control system according to the present invention.

To begin with, the mobile body control device 20 plans its own flight route and flight timing, based on a flight schedule (S101). This is performed by the takeoff and landing planning unit 23 described above.

The mobile body control device 20 then requests the ground monitoring device 10 to hold a reservation of the flight route based on the planned takeoff and landing plan. In doing so, the mobile body control device 20 transmits the flight route, the flight timing, the location of the skyport to be used, and the like according to the takeoff and landing plan (S102).

The ground monitoring device 10 having received the information including the request to hold the reservation allocates the location of the skyport where the mobile body is to take off or to land, and the flight route to be used at the time of takeoff or landing, based on the information of the takeoff and landing plan received from the mobile body, and on the flying position thereof (S103). This process is performed by the flight route allocation unit 12 described above.

The ground monitoring device 10 then determines whether there is any “interference space” in the allocated flight route (S104). The presence of the interference space is determined based on whether the allocated flight route includes any space interfering with another flight route already reserved by another mobile body. This process is performed by the flight route allocation unit 12 described above. If an interference space is present, the process goes to S105. If no interference space is present, the process goes to S106.

In S105, the ground monitoring device 10 prohibits flights along the flight route. The takeoff and landing planning unit 23 in the mobile body control device 20 receiving this information is prohibited from controlling to take the flight route.

In S106, the ground monitoring device 10 makes the flight route available for the reservation. This information is transmitted to the mobile body control device 20.

Upon receiving the notification that the flight route has been made available for the reservation from the ground monitoring device 10, the mobile body control device 20 instructs the flight control unit 21 to fly along the flight route (S107). This process is performed by the takeoff and landing planning unit 23 described above.

After the mobile body has moved out of the flight route, the mobile body control device 20 notifies the ground monitoring device 10 of the information (S108). This can be detected by a sensor or the like provided in the mobile body. This process is performed by the takeoff and landing planning unit 23 described above. As long as the mobile body has moved out of the interference space, the mobile body does not necessarily need to be completely out of the flight route. Therefore, the notification may indicate that the mobile body has moved out of the corresponding interference space.

The ground monitoring device 10 having received the information from the mobile body control device 20 releases the reservation of the flight route (S109). As a result, a reservation is made available to a next flight route sharing the interference space with the flight route.

Note that S107 and S108 can be omitted if the ground monitoring device 10 is capable of detecting that the mobile body has moved out of the flight route. In other words, the ground monitoring device 10 may determine to release the reservation of the flight route once the ground monitoring device 10 detects that the mobile body has moved out of the flight route (interference space). As another alternative method, both of the ground monitoring device 10 and the mobile body control device 20 may be configured to detect that the mobile body is out of the flight route before the reservation of the flight route is released, so that the reliability is improved.

(Effects)

As described above, by assuming flight routes including an interference space where the flight routes intersect each other, highly populated takeoff and landing on nearby skyports is made possible. In this process, by controlling the reservation process, the mobile bodies can fly safely. In addition, through a cooperation of the ground monitoring device 10 and the mobile body control device 20, the mobile bodies can be monitored and controlled efficiently and reliably. At this time, the ground monitoring device 10 can perform appropriate control by monitoring the area required for the mobile body to make a takeoff and landing. Moreover, by holding a reservation in response to a request of the mobile body control device 20, a flight route can be reserved at an appropriate timing. In addition, by determining the priorities, the efficiency of takeoff and landing can be ensured, and operations suitable for conditions and planned operations are also made possible.

The embodiment according to the present invention has been described above, but the present invention is not limited to the embodiment described above, and also include various modifications other than those described above. For example, the present invention is not limited to a configuration including all the elements in the embodiment described above. A part of the configuration of some embodiment may be deleted or replaced with another configuration. In addition, another configuration may be added to, deleted from, and replaced with a part of the configuration according to the embodiment.

For example, in the above embodiment, the reservation of an allocated flight route has been explained, but other control for recommending another flight route may be performed. For example, the ground monitoring device 10 may transmit conditions such as a prolonged waiting time, and recommend a flight route for landing on another skyport, to the mobile body control device 20, for example. In such a case, a flight route may be determined by causing the mobile body control device 20 to choose a flight route automatically, or by an operator selecting an optimum flight route.

### REFERENCE SIGNS LIST

10 ground monitoring device
11 flight position monitoring unit
12 flight route allocation unit
13 communication unit
20 mobile body control device
21 flight control unit
22 periphery monitoring unit
23 takeoff and landing planning unit
24 communication unit
51 mobile body
52 flight route
52a, 52b path
53 skyport
61 first mobile body
62 first flight route
63 first skyport
71 second mobile body
72 second flight route
73 second skyport
80 interference space

1. A mobile body control system comprising a ground monitoring device, and a mobile body control device that is capable of communicating with the ground monitoring device, wherein
the mobile body control device controls a flight of a mobile body capable of vertical takeoff and landing, and
the ground monitoring device allocates a flight route by which the mobile body makes a takeoff or landing, and when there is an interference space between one flight route and another flight route, the ground monitoring device does not permit any flight in the flight route without a reservation of the one flight route.

2. The mobile body control system according to claim 1, wherein the ground monitoring device makes the one flight route available for a reservation when another mobile body having reserved the other flight route including the interference space has moved out of the interference space.

3. The mobile body control system according to claim 1, wherein the ground monitoring device reserves a flight route of the mobile body according to a predetermined priority.

4. The mobile body control system according to claim 1, wherein the ground monitoring device determines whether the flight route is available for a reservation based on a request to hold a reservation of the flight route, the request being issued by the mobile body control device.

5. The mobile body control system according to claim 1, wherein the ground monitoring device controls a flight route of an area in which there are a plurality of skyports where the mobile body makes the takeoff or landing.

6. The mobile body control system according to claim 1, wherein the mobile body control device has a function of detecting an obstacle around the mobile body, using a sensor.
